(19) United States
(12) Patent Application Publication
(10) Pub. No.: US 2017/0219017 A1
(43) Pub. Date: Aug. 3, 2017

(54) Coupling for Floor Processing Machine

(71) Applicant: Scanmaskin Sverige AB, Lindome (SE)

(72) Inventors: Claes-Göran Bergstrand, Kullavik (SE); Martin Persson, Onsala (SE)

(73) Assignee: Scanmaskin Sverige AB, Lindome (SE)

(21) Appl. No.: 15/418,740

(22) Filed: Jan. 29, 2017

Related U.S. Application Data
(60) Provisional application No. 62/289,403, filed on Feb. 1, 2016.

(30) Foreign Application Priority Data
Jan. 29, 2016 (SE) 1650115-7

(51) Int. Cl. F16D 3/74; F16D 3/14; F16D 3/06; A47L 11/08; A47L 11/40

(52) U.S. Cl. CPC F16D 3/74; A47L 11/08; A47L 11/4069; A47L 11/4038; F16D 3/06; F16D 3/14; F16D 2003/745

(57) ABSTRACT

A device in a floor processing machine, which is drivable along a floor and has a number of floor processing tools rotatably driven by an engine with a coupling between a shaft of the engine and a shaft of a disc carrying the floor processing tools. The coupling is formed of an elastic, hole-shaped coupling ring which is slotted transversely to its circumferential direction and is connectable by its edge portions to the engine shaft and to a shaft of the coupling, respectively, the coupling ring being openable at its slotted portion for application and removal of the coupling ring to and from connection portions of the engine shaft and coupling shaft.

This application claims priority to Swedish Application 1560115-7 filed on Jan. 29, 2016, and claims the benefit of the filing date of U.S. Provisional Patent Application No. 62/289,403 filed on Feb. 1, 2016, both of which are incorporated here by reference.

The present invention concerns a device in a floor processing machine, which is drivable along a floor and having a number of floor processing tools rotatably driven by a piston engine with coupling between the engine and a shaft of a disc carrying the floor processing tools.

### BACKGROUND

Problems exist in such machines because of the fact that the vibrations of the engine undesired may be transferred to existing coupling arranged between the engine and the floor processing tools in question. Particularly, there are problems upon activation of the start of the floor processing machine and when driving and encountering harder parts of the floor that is machined using the floor processing tools. Vibrations from a machine's engine comprising pistons may easily in an undesired way propagate to the machine. Problems also exist if the shafts contact each other directly.

Known solutions of couplings are cumbersome to replace and large parts of the machine have to, in that connection, first be disassembled before the coupling can be mended and/or be replaced in case of damage to the same.

### SUMMARY

Therefore, an object of the present invention is, among other things, to solve problems mentioned above simply and efficiently.

These objects are achieved by a device according to the present invention, which includes a coupling formed of an elastic, hole-shaped coupling ring that is slotted transversely to its circumferential direction and is connectable by its edge portions to the shaft of the engine and to the shaft of a further coupling, respectively. The coupling ring is openable at its slotted portion for application and removal of the coupling ring to and from connection portions of the respective shafts.

### BRIEF DESCRIPTION OF THE DRAWINGS

The invention is described below in the form of a preferred embodiment example, reference being made to the accompanying drawings, in which:

FIG. 1 shows a schematic side view of a floor processing machine provided with a device according to the present invention,

FIG. 2 shows an enlarged view of the machine's front part with the driving arrangement of the machine shown,

FIG. 3 shows a part of the driving arrangement with couplings therefor in perspective obliquely from above,

FIG. 4 shows a cross-section view of the machine and the driving arrangement thereof,

FIG. 5 shows a side view of the driving arrangement,

FIG. 6 shows a side view of the shaft coupling of the machine, and

FIG. 7 shows a cross-section of the shaft coupling.

### DETAILED DESCRIPTION

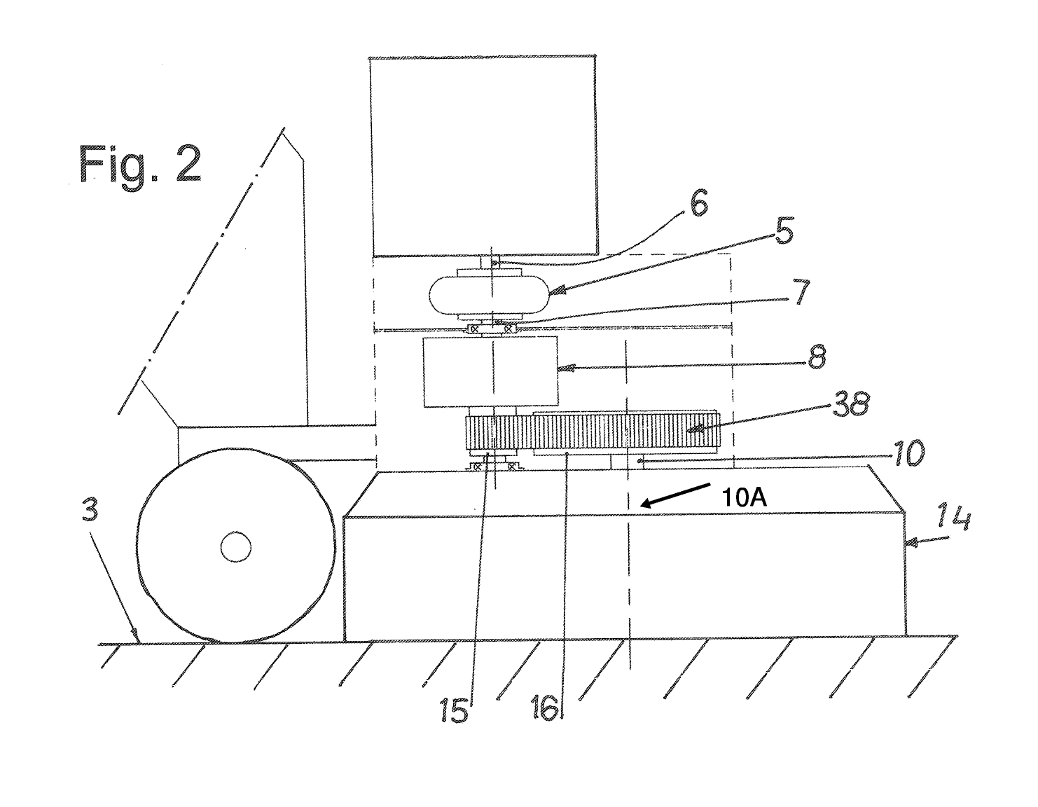

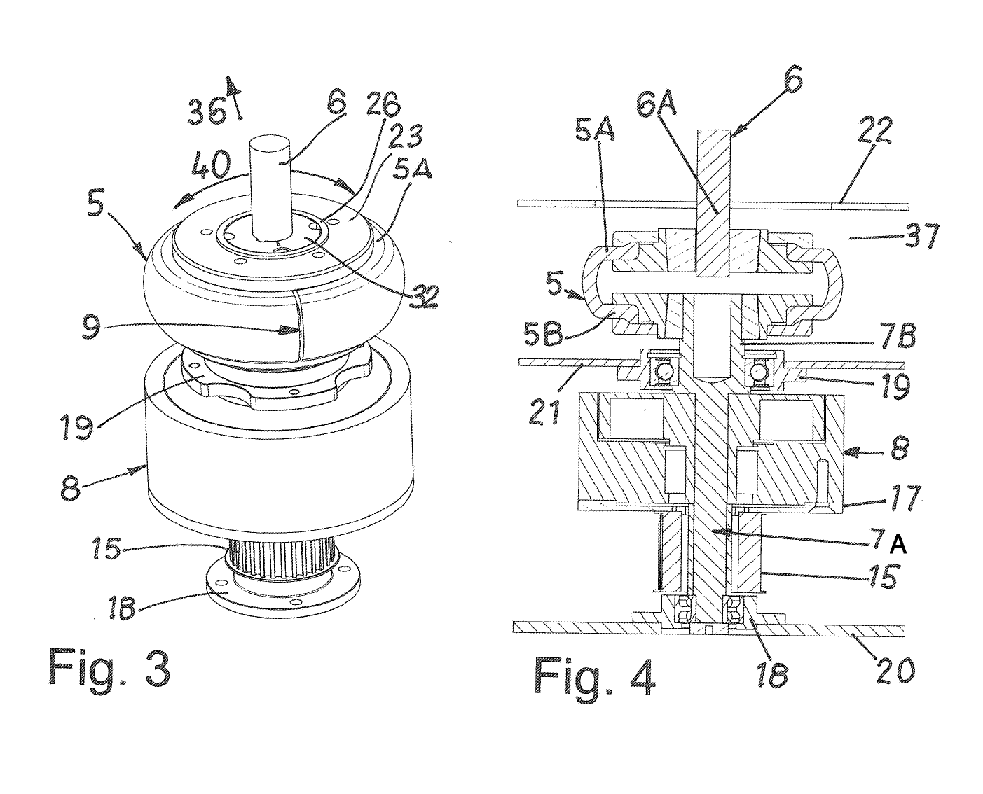

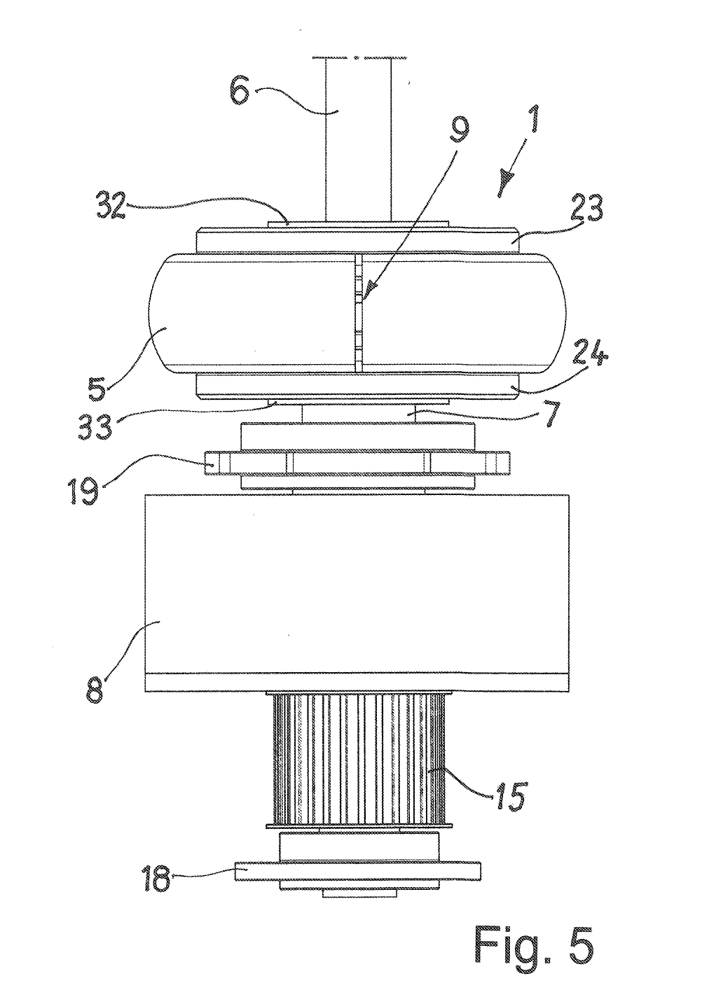

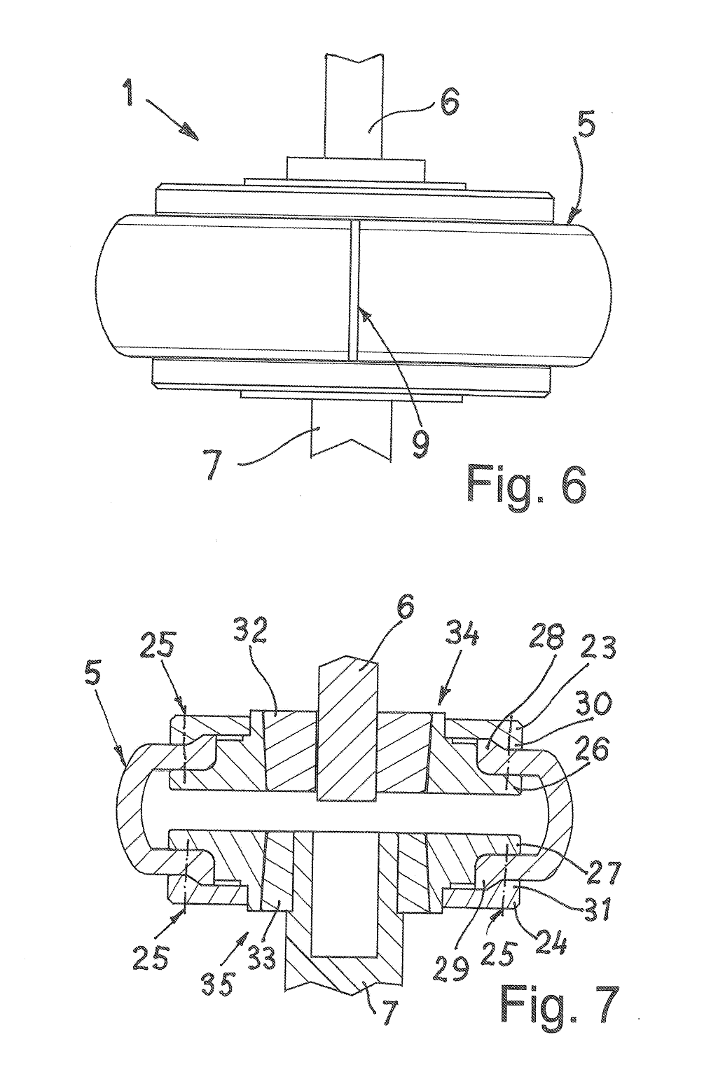

A device 1, which is situated in a floor processing machine 2 of known type, which is drivable along a floor 3, and which is provided with a number of cutting and/or grinding floor processing tools rotatably driven by an engine 4, such as a piston engine, with a shaft coupling 5 situated between the shaft 6 of the engine and a shaft 7 of a coupling 8 arranged to drive the shaft 10 of a disc 10A carrying the floor processing tools, see FIG. 2, comprises a shaft coupling 5 of a special kind. More precisely, the shaft coupling 5 is formed of an elastic, hole-shaped, tire-like coupling ring 9 slotted transversely to the circumferential direction 40 of the same. The coupling ring is connectable by its edge portions 5A, 5B to the drive shaft 6 of the engine and to a shaft 7, respectively, which is connected to a coupling 8.

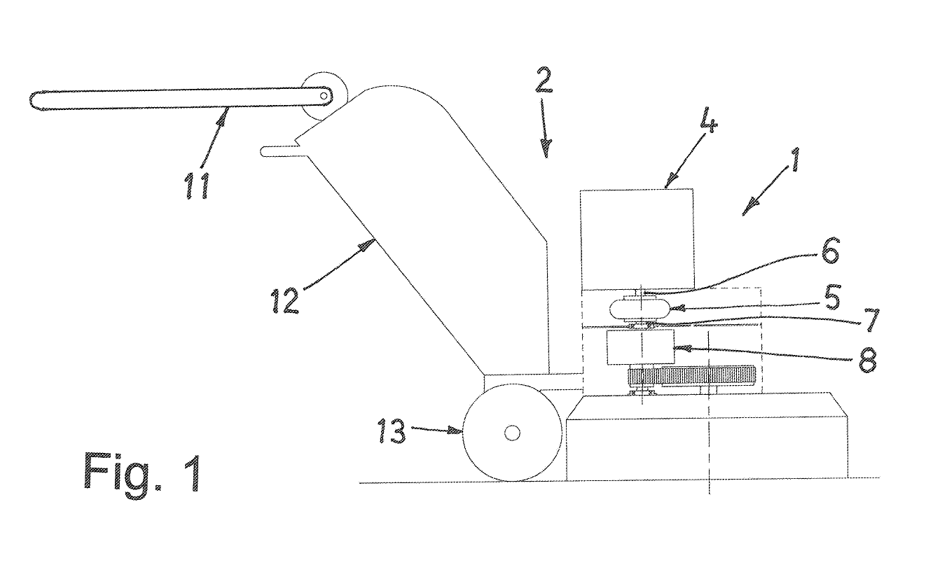

The machine 2 shown in FIG. 1 comprises in a known way a rear grip and control handle 11, a stand 12, an internal combustion engine 4, wheels 13, machine housing 14 containing the floor processing tools for the grinding and/or polishing of, e.g., stone/concrete floors 3, a shaft 10 carrying the tools on the rotating disc 10A (hidden by the housing 14), pulleys 15, 16 for a driving belt 38 and connected to the shaft 7, which is interconnected with the engine shaft 6 by the device 1 and which extends through a centrifugal coupling 8 or another suitable coupling, and the shaft 10 carrying the tool disc 10A. The smaller one 15 of the two pulleys 15, 16 is attached to a flange 17 of the centrifugal coupling 8 while the larger one 16 of the two pulleys 15, 16 is carried by the tool disc driving pulley 16.

The shaft coupling 5, which is constructed from a partible rubber bellows, works in such a way that the engine shaft 6 never comes in direct contact with the journaled coupling shaft 7, which entails that the engine shaft 6 gets minimal radial/axial effect on the coupling shaft 7 and the machine parts actuated thereby.

Stable journaling of the different parts of the machine 2 is also achieved thanks to the provision of lower bearing box 18, and upper bearing box 19 as well as mounting plates 20, 21, 22 for the lower the end 7A of the coupling shaft 7, for the upper end 7B of the coupling shaft 7, and the upper end 6A of the engine shaft 6, respectively.

The rubber bellows is preferably attachable to disc-shaped upper and lower, respectively, shaft end discs 23, 24 of the shafts 6, 7 and the attachment is suitably provided by means of bolt joints 25 (schematically shown in FIG. 7). In that connection, fixed nuts or threads in holes of the respective two shaft end discs 23, 24 may form anvils for bolts from the sides of the shaft end discs facing away.

The shaft end discs may either be rigidly connected to output shafts 6, 7 from the engine 4 and coupling 8, respectively, or, as is shown in FIG. 7, be formed of detachable discs 23, 24 and clampable anvil discs 26, 27 and between which paired discs 23, 24 and 24, 27, respectively, an end portion 28, 29 of the shaft coupling 5 is clampable. By a thickened end portion 28-31, e.g., conically, the clamping of the shaft coupling on the shafts 6, 7 is facilitated.

Internally in the anvil discs 26, 27, conical discs or press rings 32, 33 are insertable for the clamping of the anvil discs 26, 27 on surrounded shafts 6, 7.

By the fact that the anvil discs 26, 27 and press rings 32, 33, respectively, internally and externally, respectively, are conical, there are provided friction joints 34, 35 between the same and the shafts 6, 7 so that a proper, detachable clamping is provided.

The hole-shaped coupling ring, which resembles a barrow wheel, is slotted 9 substantially perpendicularly transverse to the circumferential direction 40 of the coupling ring, whereby the coupling ring easily can be loosened from one or both shafts 6, 7 after disengagement of the parts 25-33 and be pulled away from the two shafts 6, 7 in a perpendicular direction 36 from the same. This can be carried out without requirement of needing to disassemble almost the entire machine 2 as previously has been required.

In more detail, the attachment of the shaft coupling 5 is described in the following:

The coupling ring is attachable to the two separated shafts 6, 7 by a clamp coupling which comprises paired, conical lock plugs, which lockingly co-operate with respective disc-shaped lock discs likewise provided with conical counterpressure surfaces, the clamp coupling being clampable to the respective shaft 6, 7. Furthermore, the lock discs may be connectable to the respective sides of the coupling ring being diametrically opposite to each other by screw joints. Furthermore, the shaft coupling is contained in an upper space 37 between upper and lower, respectively, mounting plates 22, 21 of which have via holes for the respective shaft 6, 7 and that one mounting plate 21 carries bearings for the coupling shaft 7.

The function and nature of the invention should have been clearly understood from the above-mentioned and also with knowledge of what is shown in the drawings but the invention is naturally not limited to the embodiments described above and shown in the accompanying drawings. Modifications are feasible, particularly as for the nature of the different parts, or by using an equivalent technique, without departing from the protection area of the invention, such as it is defined in the claims.

What is claimed is:

1. A device in a floor processing machine that is drivable along a floor and has a number of floor processing tools rotatably driven by an engine with a coupling between a shaft of the engine and a shaft of a disc carrying the floor processing tools, the device comprising:
an elastic, hole-shaped coupling ring that is slotted transversely to a circumferential direction of the coupling ring and is configured to connect by edge portions to the shaft of the engine and to a shaft of the coupling, respectively, the coupling ring being openable at its slotted portion for application and removal of the coupling ring to and from respective connection portions of the engine and coupling shafts.

2. The device of claim 1, wherein the coupling ring is configured to attach to disc-shaped shaft end discs of the engine and coupling shafts.

3. The device of claim 2, wherein the coupling ring is configured to attach to the disc-shaped shaft end discs by friction joints.

4. The device of claim 2, wherein the coupling ring is configured to attach to the disc-shaped shaft end discs with bolts.

5. The device of claim 4, wherein the disc-shaped shaft end discs include fixed nuts or threaded holes for the bolts.

6. The device of claim 5, wherein the disc-shaped shaft end discs are respectively rigidly connected to the engine shaft and to a shaft from the coupling ring.

7. The device of claims 4, wherein against at least one side of the coupling ring, a disc or press ring is arranged for compression against a respective disc-shaped shaft end disc.

8. The device of claim 1, wherein the coupling ring is configured to connect to the engine shaft and coupling shaft by respective clamp couplings, each clamp coupling comprising paired, conical lock plugs that lockingly co-operate with respective disc-shaped lock discs having conical counterpressure surfaces.

9. The device of claim 8, wherein the disc-shaped lock discs connect to respective sides of the coupling ring diametrically opposite to each other by screws.

10. The device of claim 1, wherein the coupling ring is disposed between mounting plates which respectively have via holes for the engine and coupling shafts, and one of the mounting plates carries bearings for the coupling shaft.

11. The device of claim 1, wherein the coupling ring is slotted substantially perpendicular to the circumferential direction of the coupling ring.
